(19) United States
(12) Patent Application Publication
(10) Pub. No.: US 2013/0183568 A1
(43) Pub. Date: Jul. 18, 2013

(54) COMPOSITE SEPARATOR FOR ELECTROCHEMICAL CELL AND METHOD FOR ITS MANUFACTURE

(71) Applicants: Susan J. Babinec, Midland, MI (US); Patrick Hagans, Dexter, MI (US); William Hicks, Ann Arbor, MI (US); Yet-Ming Chiang, Framingham, MA (US)

(72) Inventors: Susan J. Babinec, Midland, MI (US); Patrick Hagans, Dexter, MI (US); William Hicks, Ann Arbor, MI (US); Yet-Ming Chiang, Framingham, MA (US)

(21) Appl. No.: 13/509,899

(22) PCT Filed: Nov. 18, 2010
(86) PCT No.: PCT/US10/57249

§ 371 Date: Mar. 20, 2013

Related U.S. Application Data
(60) Provisional application No. 61/262,311, filed on Nov. 18, 2009.

(51) Int. Cl. H01M 2/16

(52) U.S. Cl. CPC H01M 2/1613
USPC 429/142; 427/58

(57) ABSTRACT

An electrode/separator assembly for use in an electrochemical cell includes a porous composite layer having a total thickness in the range of about 4 μm to about 50 μm comprising inorganic particles having an average aggregate particle size in the range of about 0.5 μm to about 6 μm in an electrochemically stable polymer matrix.

### CROSS-REFERENCE TO RELATED APPLICATIONS

This application claims priority to U.S. Provisional Patent application Ser. No. 61/262,311, filed Nov. 18, 2009, entitled “Composite Separator for Electrochemical cell and Method For its Manufacture,” which is hereby incorporated in its entirety by reference.

This application is related to U.S. patent application Ser. No. 12/196,203, filed Aug. 21, 2008, entitled “Separator for Electrochemical Cell and Method For Its Manufacture,” which is hereby incorporated in its entirety by reference.

This application is related to U.S. patent application Ser. No. 12/240,855, filed Sep. 26, 2008, entitled “Batteries Having Inorganic Porous Films,” which is hereby incorporated in its entirety by reference.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### INCORPORATION BY REFERENCE

All patents, patent applications and publications cited herein are hereby incorporated by reference in their entirety in order to more fully describe the state of the art as known to those skilled therein as of the date of the invention described herein.

### BACKGROUND

1. Related Field

This disclosure relates generally to electrochemical cells. More specifically, the disclosure relates to battery cells. Most specifically, the disclosure relates to separator membranes for electrochemical battery cells

2. Description of Related Art

Separator membranes of lithium ion batteries serve to prevent contact of the anode and cathode of the battery while permitting electrolyte to pass there through. Additionally, battery performance attributes such as cycle life and power can be significantly affected by the choice of separator. Safety can also be related to separator attributes, and certain separators are known to reduce occurrence of Li metal plating at the anode and even dendrite formation while other separators are known to reduce the intensity of thermal runaway in a nail penetration test.

Separator membranes of battery cells are, in some instances, formed from bodies of polymer materials which are rendered porous. In other instances, separator membranes are formed from bodies of fibrous or particulate material, and such materials can include glass fibers, mineral fibers such as asbestos, ceramics, synthetic polymeric fibers as well as natural polymeric fibers such as cellulose.

Inorganic composite materials have been used as separators. Such composite separators can include a silica (or other ceramic) filler material and a polymer binder. The filler and binder are blended with a volatile carrier and can be extruded to form a composite sheet; volatile components are removed by extraction or evaporation to form a porous body when the amount of polymer binder is not too large. Other examples blend the filler and binder to form a mixture that is applied to a substrate by various coating means, such as doctor blading, roll coating or screen, stencil printing or gravure. In many cases, the composite separator materials contain a very high content of inorganic filler. In some instances, the separators exhibit poor properties, such as mechanical properties including a high tendency to crack and insufficient strength and ductility to be used as a free standing film.

One particular challenge for composite separators has been the manufacture of low defect separators of acceptable thickness, especially when coated onto a substrate such as an electrode. In current lithium ion batteries using polymer separator, a free standing film used as the separator has a thickness of about 25 μm. When deposited on electrodes at these thicknesses, a composite separator tends to crack during the removal of the volatile carrier. In general, cracking can be reduced by increasing the polymer content of the composite; however, porosity and so ion conductivity is reduced with increasing polymer content. This loss of conductivity renders the separator unusable in batteries. Separators of suitable thickness can be obtained using multiple coating and drying steps; however, multiple processing steps increase costs and introduce variability into the process and do also have thickness limitations, although these are less severe with the multiple coating approach.

### BRIEF SUMMARY

It is understood that any of the embodiments described below can be combined in any desired way, and any embodiment or combination of embodiments can be applied to each of the aspects described below.

A separator for electrochemical cells is described. The composite separator membranes are efficiently produced, low in cost, safe and easy to utilize as either a coating or as a free standing film. This separator is a composite of inorganic particles and polymeric binder whose individual constituent characteristics are chosen to provide properties of the composite which are advantaged over other composites. The separator composite materials are low in cost and function to provide high performance membrane structures which can have excellent adhesion to electrodes and which improve safety due to their high dimensional stability at high temperatures. These separator composite materials may be used as free standing films and wound as usual into an electrode assembly using the existing technology for porous polymer separator membranes. Furthermore, the membrane materials may also be directly coated onto electrodes of the battery in a manner which is advantaged over other composite separators, thereby simplifying fabrication and handling procedures. This electrode/membrane assembly exhibits excellent adhesion between the layers and does not delaminate from its substrate (current collector) even when wound, bent, flexed or otherwise deformed

The inorganic/polymer composite separator can be coated onto electrodes (either or both anode and cathode) and provides several advantages. In comparison to traditional free standing polyolefin separators, this separator is lower cost. The inorganic/polymer composite separator has superior durability at elevated temperatures. At >110° C. it does not shrink, which enables faster cell drying prior to fill, and at temperatures greater than 160° C. it maintains mechanical integrity/durability which makes the cell safer in abuse situations. In comparison to other composite separators, the combinations described provide a resistance to cracking when coated onto electrodes and an ability to be used as free standing films. These advantages are due to the specific characteristics of the constituent materials.

In one aspect, a separator for an electrochemical cell includes a porous composite layer having a total thickness in the range of about 4 μm to about 50 μm comprising inorganic particles having an average aggregate particle size in the range of about 0.5 μm to about 6 μm in an electrochemically stable polymer matrix, said layer being substantially free from defects, such as cracks.

In any of the embodiments described hereinabove, the layer has a pore volume fraction of greater than 25%, or a pore volume fraction of about 50% to about 70%.

In any of the embodiments described hereinabove, the layer has a total thickness in the range of about 15 μm to about 40 μm.

In any of the embodiments described hereinabove, the separator is supported on an electrode, or the separator is of sufficient mechanical strength to provide a free standing layer.

In any of the embodiments described hereinabove, the inorganic particles have an average aggregate particle size in the range of about 2 μm to about 6 μm, or the inorganic particles have an average aggregate particle size in the range of about 3 μm to about 4 μm, or the inorganic particles have an average aggregate particle size in the range of about 0.5 μm to about 3 μm, or the inorganic particles have an average aggregate particle size in the range of about 1 μm to about 2.5 μm.

In any of the embodiments described hereinabove, the inorganic particles are selected from the group consisting of natural and synthetic silicas, zeolites, aluminas, titanias, metal carbonates, zirconias, silicon phosphates and silicate and the like of suitable average aggregate particle size, and includes for example, precipitated silica.

In any of the embodiments described hereinabove, the composite layer includes inorganic particles and polymer binder in a weight ratio of about 95:5 to about 35:65 inorganic particles:polymer, or about 65:35 to about 45:55 inorganic particles.

In any of the embodiments described hereinabove, the polymer comprises a polymer which is electrochemically compatible with Li-ion cells, and is for example, selected from the group of latex polymers, cellulosics, and polyvinylidene fluoride-based polymers.

In any of the embodiments described hereinabove, the layer has a Gurley number of less than about 2, or the layer has a Gurley number of less than about 1 when tested via ASTM-D726 using 100 cubic centimeters of air.

In another aspect, an electrode/separator assembly for use in an electrochemical cell includes a first electrode layer disposed on a current collector, said electrode layer comprising at least electroactive particles and a binder; a second electrode layer disposed on a current collector, said electrode layer comprising at least electroactive particles and a binder; and a porous composite separator layer according to any of the preceding embodiments.

In any of the embodiments described hereinabove, the separator layer has a total thickness in the range of about 20 μm to about 40 μm.

In any of the embodiments described hereinabove, a portion of the separator thickness is disposed on each of the electrode layers.

In another aspect, a method of preparing a electrode/separator assembly for an electrochemical cell includes providing a coating solution, said coating solution comprising a polymer, solvent system for solubilizing at least a portion of said polymer, and inorganic particles having an average aggregate particle size of about 0.5 μm to about 6 μm dispersed in said coating solution; coating a surface with a layer of said coating solution, at a thickness to provide a final thickness, after solvent system removal, of about 12-50 μm; and removing at least a portion of the solvent system from said coating solution layer to deposit a porous separator. Optionally, the average aggregate particle size is about 1 μm to about 6 μm.

In any of the embodiments described hereinabove, the surface comprises a porous composite electrode layer including at least electroactive particles and a binder, the surface comprises a non-porous surface that is chemically inert with respect to the coating solution.

In any of the embodiments described hereinabove, the method further includes curing the polymer.

In any of the embodiments described hereinabove, curing includes heat treating the assembly.

In any of the embodiments described hereinabove, the coating solution includes a weight ratio of silica particles and polymer in the coating solution of about 95:5 to about 35:65, or about 65:35 to about 45:55.

In any of the embodiments described hereinabove, the solvent system can be a mixture of solvents and the solvents include a first liquid that is a solvent for the binder and a second liquid that is a poorer solvent for the binder than the first liquid and the proportion of first and second liquids is selected to limit the dissolution of the binder in the electrode during the coating step.

In any of the embodiments described hereinabove, the solvent system can be a mixture of solvents and the solvents include a first liquid that is a solvent for the binder and a second liquid that decreases the viscosity of the coating solution. Optionally, the proportion of first and second liquids vs. the amount of solids is selected to reduce the penetration of the coating solution into the thickness of the electrode layer.

In any of the embodiments described hereinabove, the solvent system includes N-methyl pyrrolidone, or the solvent system includes a mixture of N-methyl pyrrolidone and a diluting solvent selected from the group consisting of acetone, cyclohexanone, propyl acetate, methyl ethyl ketone and ethyl acetate.

In any of the embodiments described hereinabove, coating is carried out by slot die coating.

In any of the embodiments described hereinabove, removing the solvent includes evaporating said solvent.

In another aspect, a battery which includes the separator membrane described in any of above described embodiments, and for example, the battery is a lithium ion battery.

### BRIEF DESCRIPTION OF THE SEVERAL VIEWS OF THE DRAWINGS

The invention is described with reference to the figures listed below, which are presented for the purpose of illustration only and are not intended to be limiting of the invention.

FIG. 1 is a schematic illustration of a cell including a composite separator according to one or more embodiments;

FIG. 2 is a scanning electron micrograph (SEM) image (6000×) of as-received silica indicating the particle irregularity and high degree of surface roughness.

FIG. 3 is a scanning electron micrograph (SEM) image (5000×) of the silica particles of FIG. 2 in a polymer coated composite film, indicating the reduction in particle irregularity and surface roughness.

FIG. 4 is a scanning electron micrograph (SEM) image (7000×) of a PVDF-coated particle in which bridging PVDF polymer is evident.

FIG. 5 is a scanning electron micrograph (SEM) image (35000×) of a PVDF-coated particle, in which polymer bridging of the silica particle with PVDF is observed.

FIG. 6 is a schematic diagram indicating processing steps for coating a porous composite layer according to one or more embodiments.

FIG. 7 is a plot of % initial capacity vs. cycle number and DC resistance vs. cycle number in a 1.5 C/−2.5 C room temperature low power cycle test for a cell including a 30 μm composite separator according to one or more embodiments.

FIG. 8 is a plot of impedance for (1) a cell including a 22 μm nanoporous separator using fumed 65/35 fumed silica/PVDF and (2) a cell including a 30 μm microporous separator using a single 30 μm layer of 65/35 silica/PVDF on the cathode, (3) a cell including a 30 μm microporous separator using a single 30 μm layer of 65/35 silica/PVDF on the anode, and (4) a cell including two 15 μm layers of 65/35 silica/PVDF on each electrode.

FIG. 9 is a plot of % initial capacity vs. cycle number for (1) a non-laminated microporous separator, (2) a laminated microporous separator with low compaction, (3) a laminated microporous separator with high compaction, and (4) a non-laminated polyolefin separator baseline material.

### DETAILED DESCRIPTION

A porous composite membrane having simplified fabrication, improved safety, and enhanced operational performance is described. The porous composite membrane can be used as a separator membrane in an electrochemical device such as a battery, for example, a secondary Li ion battery. In one implementation, the separator is an inorganic/polymer composite separator that is relatively thick (e.g., having a thickness of about 4 to about 50 μm) and comprises inorganic particles having an average aggregate particle size in the range of about 0.5 μm to about 6 μm in an electrochemically stable polymer matrix. In other implementations, the average aggregate particle size is about 1 μm to about 6 μm and the layer thickness is about 8 μm to about 50 μm. The terms “average aggregate particle size” and “average particle size” are used interchangeable herein. The composites are substantially crack-free and possess sufficient physical strength that it can be a free standing film without having excessive thicknesses, for example at a thickness less than about 50 μm. As used herein, the term “free standing film” describes a film that maintains its structural integrity without the need to be laminated or bound to another material. In addition, the separator membrane can be prepared over a range of porosities, while providing adequate ionic conductivity and mechanical strength. The use of inorganic particles on the micron—and not the nanometer—scale provides porosity without the brittleness or friability sometimes observed in nanocomposite separators. While large particle composites, e.g., with an aggregate particle size of greater than 10 μm, produce porous composites with mechanical strength, the particle size provides an unacceptable lower limit to separator thicknesses. It has been surprisingly observed that composite separators using particles having an average aggregate particle size in the range of 0.5-6 μm provides exceptional porosity and mechanical strength at composite layer thicknesses of less than 50 μm.

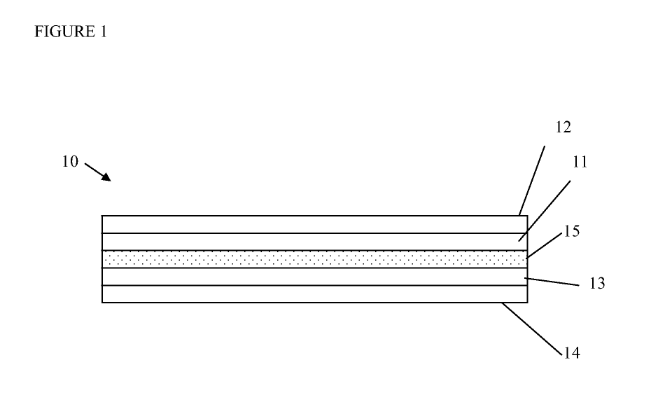

Reference is made to FIG. 1, which illustrates an exemplary electrochemical cell 10 including a cathode active layer 11, a cathode substrate or current collector 12, an anode active layer 13 and an anode substrate or current collector 14. The cathode and/or the anode active layer typically include a porous particulate composite including an electrode active material, a conductive additive and a polymer binder. A porous composite separator 15 separates the electrode layers. A liquid electrolyte permeates the porous separator membrane. The current collector is in contact with its respective electrode layer to permit current flow during charge and discharge cycles of the electrochemical cell. The cells may be stacked or wound together to form a prismatic or spirally wound, e.g., cylindrical, cell. In such instances, the electrode may be coated on both sides with an electroactive layer. The electrode may also be wrapped with a free standing film of the composite separator, using traditional cell building technology.

As used herein, “cathode” and “positive electrode” are used interchangeably. Also as used herein, “anode” and “negative electrode” are used interchangeably.

Also, as used herein, “particle size” refers to the aggregate particle size. Aggregate particle refers to branched and/or clumped chains of fused primary particles. Aggregate particle size refers to the average maximum dimension of the aggregate particles and not the primary particles making up the aggregate particle. Aggregates are further distinguished from agglomerates, which are loose associations of aggregates that can be readily dispersed. In an illustrative implementation, one particular silica sold under the trademark Syloid C803 by W.R. Grace is used. The Syloid material has an average particle size of 3.4-4.0 μm as determined by a Malvern Mastersizer 2000 according to the Grace Q 013 testing method. However, it is recognized that several methods exist for measuring average particle size, and that these other methods can be used to determine appropriate particle sizes for use in the embodiments.

The cathode layer 11 may be a porous composite particulate layer. The cathode active material may be a conventional cathode active material for a lithium ion secondary battery, such as a lithium-transition metal-phosphate compound, LiCoO₂, LiNiO₂ or LiMn₂O₄ and, the like. The lithium-transition metal-phosphate compound may be optionally doped with a metal, metalloid, or halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen.

The anode layer 13 may also be a porous composite particulate layer. In one embodiment, the negative active material is a carbonaceous material or a lithium intercalation compound. Exemplary lithium intercalation compounds include lithium titanate. Exemplary carbonaceous materials are non-graphitic or graphitic. A graphitized natural or synthetic carbon can serve as the negative active material. Although non-graphitic carbon materials or graphite carbon materials may be employed, graphitic materials, such as natural graphite, spheroidal natural graphite, mesocarbon microbeads and carbon fibers, such as mesophase carbon fibers, may be used. The carbonaceous material has a numerical particle size (measured by a laser scattering method) that is smaller than about 25 μm, or smaller than about 15 μm, or smaller than about 10 μm, or even less than or equal to about 6 μm.

The electroactive material, conductive additive and binder are combined to provide a porous composite electrode layer that permits rapid lithium diffusion throughout the layer. The conductive additive such as carbon or a metallic phase is included in order to improve its electrochemical stability, reversible storage capacity or rate capability. Exemplary conductive additives include carbon black, acetylene black, vapor grown carbon fiber (“VGCF”) and fullerenic carbon nanotubes. Conductive additives are present in a range of about 1%-5% by weight of the total solid composition of the electrode. The binder used in the electrode may be any suitable binder used as binders for non-aqueous electrolyte cells. Exemplary materials include a polyvinylidene fluoride (PVDF)-based polymers, such as poly(vinylidene fluoride) (PVDF) and its co- and terpolymers with hexafluoroethylene, tetrafluoroethylene, chlorotrifluoroethylene, poly(vinyl fluoride), polytetraethylene (PTFE), ethylene-tetrafluoroethylene copolymers (ETFE), polybutadiene, cyanoethyl cellulose, carboxymethyl cellulose and its blends with styrene-butadiene rubber, polyacrylonitrile, ethylene propylene diene terpolymers (EPDM), styrene-butadiene rubbers (SBR), polyimides, ethylene-vinyl acetate copolymers.

The cathode and/or anode electrode layers can be manufactured by applying a semi-liquid paste containing the appropriate electroactive compound and conductive additive homogeneously dispersed in a solution of a polymer binder in an appropriate casting solvent to both sides of a current collector foil or grid and drying the applied positive electrode composition. A metallic substrate such as copper or aluminum foil or expanded metal grid is used as the current collector. To improve the adhesion of the active layer to the current collector, an adhesion layer, e.g., thin carbon polymer intercoating, may be applied. The dried layers are calendared to provide layers of uniform thickness and density.

Separator membrane 15 is a porous composite material including inorganic filler (e.g., ceramic, which is used interchangeably with “inorganic filler” herein) particles and polymer. The separator is formed from a highly uniform distribution of inorganic filler material and polymer, that is, although the aggregated particle size of the filler material may vary within a range, there is no discernible unevenness or gradient in the distribution of polymer and the filler material throughout the membrane. There are substantially no regions of the membrane having discernible regions of predominantly polymer or predominantly ceramic material. This highly uniform distribution is observable even under high magnifications typical of SEM microscopy. The separator materials should be electronically insulating when used in an electrochemical cell.

Prior inorganic/polymer composite separators crack readily and this issue becomes more significant as the thickness of the separator membrane is increased, which provides a practical limitation on the thickness of a single composite layer and/or requires multiple layers to achieve a desired thickness. In one or more embodiments, the separator membrane includes a thick separator composite layer that is substantially crack-free. The separator membrane layer can be applied at the desired total thickness to one electrode, or both the anode and the cathode may be coated with a porous composite layer, of the same or different composition and thickness. In those instances where both the cathode and anode are coated with a porous composite layer, the amount deposited from each layer can be reduced. For example, where it is desired to form a composite separator of about 30 μm, both the cathode and the anode can be coated to form a layer thickness that is substantially half the desired amount. A ‘substantially crack-free’ composite separator layer does not have any crack, hole, defect, or non-uniformity that is observable under optical microscope at a magnification of 100×. In some embodiments, no crack or defect or non-uniformity is observed at a magnification of 500× or even 800×. An additional method to test if a composite separator layer is substantially crack-free is to subject a dry cell (i.e., a cell without an electrolyte), including the composite separator layer, to a high potential test, in which a voltage in the amount of 250-500 V is applied across the cell. If current is observed, then the cell is considered to have failed the test. Holes, cracks, and other defects in a separator layer can exhibit dielectric breakdown and permit current to pass in such a test and result in failure.

It can be desirable to have the separator layer be as thin as possible in many cases, as this decreases the ionic resistance and increases capacity and power in the cell. However, the separator has a minimum thickness to provide the desired mechanical strength to the separator. In some embodiments, the separator should be strong enough to withstand the battery assembly process and possess sufficient mechanical integrity to withstand punctures and other damage. The separator membrane can have a thickness in the range of about 12-50 μm. In one or more embodiments, the thickness is in the range of about 12 μm to 30 μm. In other embodiment, composite separators have been applied at a thickness of about 45 μm on the cathode and 45 μm on the anode without any cracks. As the total thickness, e.g., a total of 90 μm, is greater than one would typically use in a lithium ion battery, this illustrates that there is essentially no cracking limitation to the separator provided according to one or more embodiments. A cell with a total thickness of greater than 22-25 μm that is currently used can offer advantages of greater durability, lower current leakage and longer shelf life. Thicker coatings can help compensate for the occasional defect that can arise during coating or handling after coating is complete.

The composite separator includes a polymer and an inorganic filler particle, in which the inorganic filler particles are in the micrometer, and not the nanometer, scale. It has been surprisingly discovered that inorganic filler particles having an average aggregate particle size in the micrometer range can be used to readily form a composite layer with high porosity, high ionic conductivity at thicknesses of greater than 20 μm without cracking or to prepare a free standing film having sufficient mechanical integrity to be handled without damage. The inorganic particles have an average particle size with a maximum dimension of about 0.5 μm to about 6 μm, or about 0.5 μm to about 3 μm, or about 1 μm to about 2.5 μm. In one or more embodiments, the ceramic material is inorganic, e.g., a ceramic, having a large particle size distribution and variable shape, e.g., including spherical, elliptical and very randomized. Other compounds may be utilized as an inorganic component of the membranes, such as for example, polyhedral oligomeric silesquioxane (poSS), which in the context of this disclosure is considered to be an inorganic material. Other inorganic materials include natural and synthetic zeolites, aluminas, titanias and the like of suitable average aggregate particle size. In addition, other electrochemically stable inorganic particles of appropriate size can be used, e.g., MgO, CaCO₃ and other metal carbonates, zirconias, silicon phosphates and silicates. The inorganic materials may be used either singly or in combination, with uniform or mixed sizes and shapes as well.

In one or more embodiments, the inorganic filler particles include silica having an average aggregate particle size of about 0.5 μm to about 6 μm, or about 2 μm to about 6 μm, or about 3 μm to about 4 μm. The silica particles can be precipitated silica, colloidal silica, silica gels, or particles formed by milling quartz. Moreover, the particles can be prepared by a number of techniques known in the art, so long as the particle size is within the size ranges disclosed herein. One particular silica having an average particle size of 3.4-4.0 μm is sold under the trademark Syloid C803 by W.R. Grace. The average aggregate particle size of silica according to one or more embodiments of the invention is significantly larger that fumed silica, which typically has an aggregate size less than 0.5 microns and in the range of 100 nm. The particle size distribution is large; although the average particle size is 3-4 μm, there is a significant population of particles of about 0.5 μm, e.g., the particle can measure as large as about 8 μm and as small as about 0.25 μm. Literature data for silica suggest that there is a large particle size distribution, for example, of about 2 orders of magnitude.

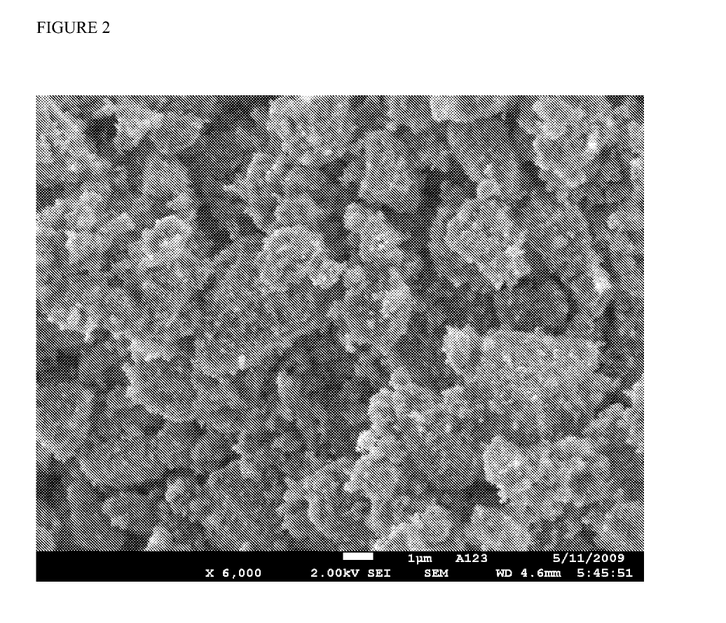

In one or more embodiments, the silica particles have a relatively high surface area to weight ratio. For example, precipitated and colloidal silicas are available in a large range of surface areas—from 5-400 m²/gram) despite the fact that the particle sizes are relatively large. For example, Syloid C308 silica has higher surface area than the fumed silica (366 vs. 100 m²/gram) even though the particle size is larger. The high surface area may be due to roughness and non-uniform particle structure. A scanning electron micrograph (SEM) image of Syloid C308 silica particles at 6000× magnification is shown in FIG. 2. The image indicates that particles are non-spherical and show considerable surface roughness. Thus, the characteristics of the resultant composite separator are not correlated to the surface area of the silica, but rather the particle size.

In one or more embodiments, mixtures of different silicas are contemplated. By way of example, a silica having an average particle size of about 2-6 μm (“larger particle silica”) can be combined with a fumed silica, e.g., a fumed silica having a particle size of about 0.2 μm and a surface area of about 100 m²/g or higher. Mixtures of larger particle silica and fumed silica can demonstrate the benefits of both materials. For example the pores of the larger particle silicas can be a potential sight for Li dendrite growth. These pores can be narrowed by blending larger particle silica with smaller particle fumed silicas which would be expected to at least partially fill and/or close pores of the host silica structure and reduce dendrite formation.

The polymer is selected from those polymers which are compatible with the chemistry of a particular battery system. The polymer should be electrically insulating, have low solubility in electrolyte solvents and be chemically and electrochemically stable in the cell. The polymer may be a single polymer or a mixture of polymers. Thus, as used herein, the term “polymer” encompasses a single type of polymer as well as a mixture of polymers even though the singular of the term is used. Exemplary materials include a polyvinylidene fluoride (PVDF)-based polymers, such as poly(vinylidene fluoride) (PVDF) and its co- and terpolymers with hexafluoroethylene, tetrafluoroethylene, chlorotrifluoroethylene, poly(vinyl fluoride), polytetraethylene (PTFE), ethylene-tetrafluoroethylene copolymers (ETFE), polybutadiene, cyanoethyl cellulose, carboxymethyl cellulose and its blends with styrene-butadiene rubber, polyacrylonitrile, ethylene propylene diene terpolymers (EPDM), styrene-butadiene rubbers (SBR), polyimides, ethylene-vinyl acetate copolymers, poly(acrylic acid) (PAA), and the lithium form of PAA. One group of polymers having utility in lithium and lithium ion battery systems, as well as other battery systems, includes fluorinated polymers and latex polymers such as styrene butadiene and other styrene-based polymers. Polyvinylidene fluoride polymer compositions including polyvinylidene fluoride copolymers and terpolymers are one group of polymers having specific utility. There are a variety of such materials known and available in the art, and such materials may comprise essentially homogeneous PVDF as well as blends and copolymers. One particular material is a PVDF material sold under the trademark Kureha 7208. Other equivalent and similar materials may likewise be employed. See, for examples, the materials discussed above for the preparation of the anode and cathode active layers.

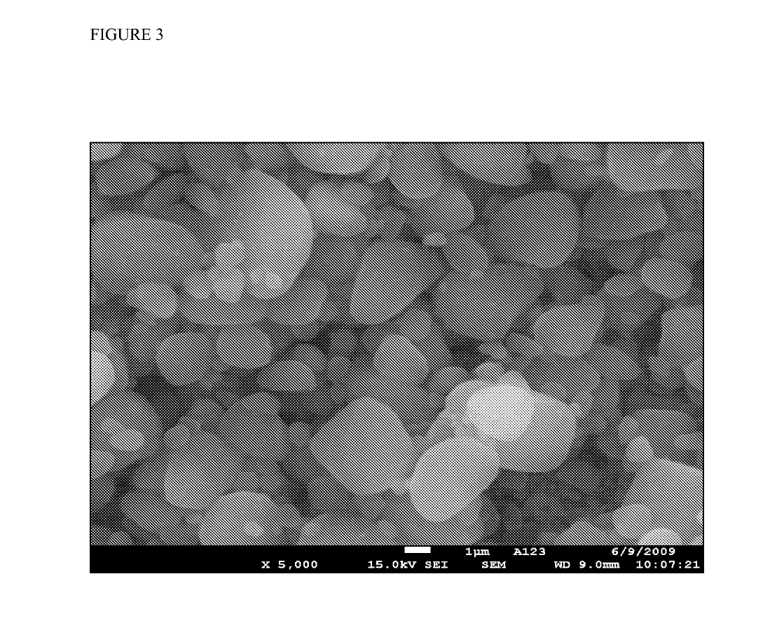

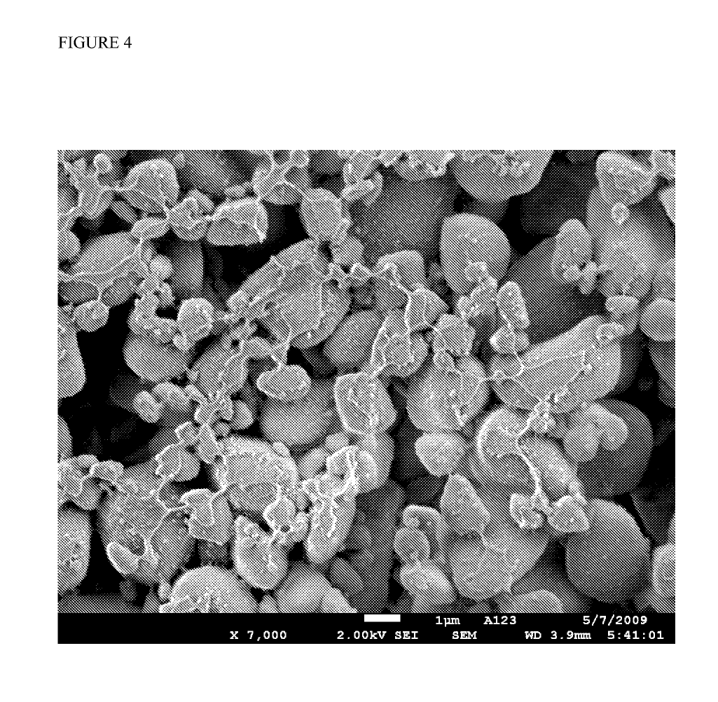

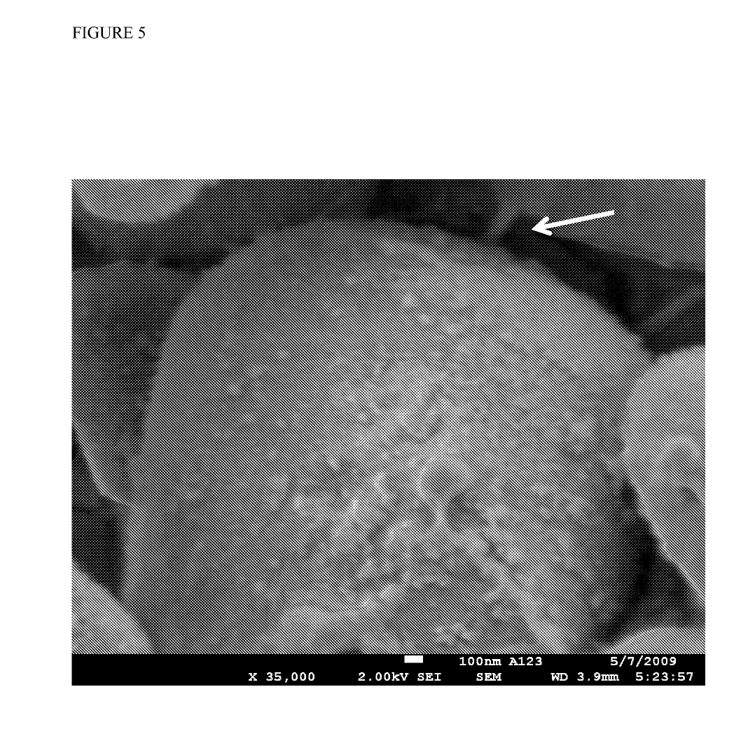

In one or more embodiments, the polymer and inorganic, e.g., silica, particles are uniformly distributed throughout the composite separator layer and in some embodiments, the silica particles are partially or fully coated with polymer. The surface roughness of the silica particle is reduced in the final composite as is illustrated in FIG. 3. A scanning electron micrograph (SEM) image of Syloid C308 silica particles-PVDF composite at 5000× indicates that much of the initial silica particle roughness is no longer present in the polymer coated films. Without being bound by any particular theory or mode of operation, the mixing process may smooth out the rough surfaces and/or the polymer may fill in some of the surface roughness. In one or more embodiments, the polymer forms a substantially continuous coating around the ceramic particles. In one or more embodiments, the particles of the composite layer are coated with a connected network of polymer. In addition, small polymer strands have been observed to bridge between adjacent silica particles in the bulk of the film. A typical structure observed on top and bottom surfaces of a silica-PVDF composite layer is shown in the SEM image (7000×) of FIG. 4. Several interesting features are observed. The large particle size distribution is evident, as is the polymer network spanning adjacent silica particles. The surface roughness is significantly less than in the as-received silica particles. The particle size distribution on the upper and lower surfaces of the layer are not significantly different, indicating that there is no significant separation or settling of smaller particles from larger particles during coating. FIG. 5 is a higher magnification SEM image (35000×) of a PVDF-coated particle; PVDF ‘fibrils’ that bridge silica particles are indicated by the arrow in FIG. 5.

The composite separators when using silicas of large particle size are surprisingly mechanically strong as compared to comparable composite separators using fumed silicas. In fact, it is possible to prepare the composite separator as a free-standing film while maintaining porosity of greater than 50%. In some embodiments, free standing films are prepared with porosities of greater than about 50%, or about 60% or about 70%, at thicknesses of less than about 50 μm, or less than about 40 μm, or less than about 30 μm. To prepare a free standing film, the composite is cast against a nonporous surface, treated to remove the solvent system and cure the composite body (see below for general discussion of appropriate casting systems and curing conditions) and removed from the surface. The composite layer has sufficient mechanical strength to maintain its physical integrity without a support. This property is a characteristic of composites prepared with the larger sized silicas but not of the smaller particle silica based composites, e.g., fumed silicas.

In order to improve conductivity, the porosity of the separator is desirably high and the pores are relatively large. Higher porosity increases the volume content of the electrolyte in the separator when the battery is assembled, which improves the ionic transport through the separator. Porosity of the composite is a function, as least in part, of the relative proportion of polymer in the composite. Higher polymer content typically results in lower total pore volume (porosity) as the polymer fills some of the interstitial space between particles. The total pore volume is selected to be sufficient to provide the desired level of ionic conductivity and is typically at least 25%, but can be greater than 50%, or greater than 75%, and even up to 90% in some instances. In one or more embodiments, the porosity of the composite separator is about 60-65%. The pore sizes cover a relatively large range and, based on SEM micrographs, appear to be between about 0.3 μm to 3 μm. Much of the porosity is complex as a channel traverses from one side of the separator to the other, for example a pore may be 3 microns at one position and 0.3 microns at an adjacent site. Pore size and pore size distribution may be determined using conventional methods. By way of example, pore size may be determined using thermoporometry, by mercury porosimetry, liquid displacement methods and gas sorption techniques. Porosimetry is a technique used to determine pore diameter, total pore volume, surface area, and density. The technique involves the intrusion of a non-wetting liquid (often mercury) at high pressure into a material through the use of a porosimeter. The pore size can be determined based on the external pressure needed to force the liquid into a pore against the opposing force of the liquid's surface tension. Exemplary total porosity measurements of compositions containing a range of silica (balance PVDF) are found in Table 1.

TABLE 1
Total % Porosity vs. Composition

| % Inorganic | Total % Porosity | Total % Porosity |
|---|---|---|
| Filler | Free standing film | coated on an electrode |
| 35 | 44 | 48 |
| 45 | 56 | 68 |
| 65 | 75 | 69 |

The proportions of polymer and inorganic materials may vary over a relatively wide range and play an important role in both mechanical and electrochemical properties. In some instances, the ratio of ceramic to polymer may range, on a weight basis, from 95:5 to 35:65. In some instances, the ratio of ceramic to polymer may range, on a weight basis, from 65:35 to 45:55. In one specific instance, the membrane comprises, on a weight basis, approximately 65% silica and 35% PVDF. In one or more embodiments, the solids load of the coating solution from which the film or coating is made is about 1 wt % to about 20 wt %, or about 7 wt % to about 15 wt %.

The presence of a significant amount of organic polymer component is distinguishable from prior art compositions, which are predominantly inorganic (>90:10) and which typically use significantly smaller particle size ceramic materials. Without being bound to any particular mode of operation, it is hypothesized that an appropriate amount of polymer organic is that which provides flexibility and mechanical strength, without impeding the porosity provided by the packing of the particles of the inorganic filler material. Higher polymer levels also promote the fusion bonding of adjacent porous layers in an electrochemical cell prepared using the porous separator membrane. Larger particles make composites with larger pores. When pores are larger, a greater amount of polymer can be added without collapsing the pore opening. Thus the use of larger particles enables the maintenance of porosity at higher binder levels and so a more flexible composite is obtained without compromise to porosity. Increased flexibility reduces the cracking tendency of coatings and enables the production of mechanically viable free standing films and relatively thicker coatings on electrodes. For example, it is difficult to obtain a 20 μm thick separator layer using fumed silica alone without experiencing cracking in the layer.

It has been surprisingly discovered that the composite separators according to one or more embodiments, exhibit higher lithium ion conductivity and lower resistance than prior art composite separators prepared from nanoscale silica particles, e.g., fumed silica, at comparable polymer loads, while maintaining relatively low cost and high flexibility. By way of example, a nanocomposite separator prepared using 65% fumed silica and 35% PVDF and having a porosity of 60-65% exhibited a conductivity of 0.4 mS/cm. A microcomposite separator prepared using 65% silica (3.0-4.0 μm) and 35% PVDF and having a porosity of 60-65% exhibited a conductivity of 2.5 mS/cm. In comparison, a microporous polyethylene separator recognized as having high transport and ionic conductivity (sold by Asahi Kasei under the trade name IBS) has an ionic conductivity of 2.9 mS/cm. Bulk conductivity can be measured using standard electrochemical impedance spectroscopic analysis on free standing films, a method well known to those skilled in the art. The sin wave voltage amplitude is 20 mvolt, the applied potential is the open circuit potential, and the frequency spectrum is 10⁻² to 10⁶ Hz. The plot is imaginary vs. real impedance and the resistance used to calculate the material properties is the impedance value when the capacitance is lowest—this is the intercept of the x-axis. The bulk conductivity is determined from this resistance value (ohms) the thickness of the film and the film surface area using the equation

R=(ρ)(L)/(A) and δ=1/ρ, where:
R=resistance (ohms) measured in AC impedance experiment above (high frequency intercept);
L=path length for the measurement−composite film thickness (cm);
A=composite film cross sectional area (cm²);
ρ=bulk resistivity (ohm·cm); and
δ=bulk conductivity S/cm or 1/ohm·cm=1/ρ.

Separators should not limit the electrical performance of the battery. Typically the separator increases the effective resistance of the electrolyte by a factor of 5-10. Composite separators, according to one or more embodiments, may lower electrical resistance in comparison to prior art separators of comparable thickness and porosity, or have a resistance which equals that of high performance, high rate separators. Without being bound by any particular theory or mode of operation, it is believed that the improved ion conductivity and reduced resistance of composite separators prepared from large particles (for example, larger particle silica, as compared to composite separators prepared from fumed silica) is due to the difference in pore size and tortuosity arising in the two composites due to the differences in both the size, shape and size distribution of the silica particles. Tortuosity is often correlated with the Gurley number, when films are of equal thickness. Air permeability is often defined in terms of the Gurley number. Air resistance is often proportional to electrical resistance for a given separator type. The Gurley second or Gurley unit for our analysis is a unit describing the number of seconds required for 10 cubic centimeters (1 deciliter) of air to pass through 1.0 square inch of a given material at a pressure differential of 4.88 inches of water (0.188 psi). This method is a modification of the standard test method for Gurley number described in ASTM-D726, which uses 100 cc of air. When the total porosity and thickness of the separators are fixed, the Gurley number reflects the tortuosity of the pores within the separator. A lower Gurley number means some combination of higher porosity and lower tortuosity and, accordingly, lower electrical resistance. In one or more embodiments, the composite separator has a Gurley number of less than 5 or less than 2 or less than 1. In some embodiments, the composite separator has a Gurley number of about 0.5. In comparison, a microporous polyethylene separator recognized as having high transport and ionic conductivity (sold by Asahi Kasei under the trade name IBS) has a Gurley number of 3.3. The ratio of the resistance of the separator filled with electrolyte divided by the resistance of the electrolyte alone is called the MacMullin number and it is used as a measure of the resistance introduced by the separator which is impendent of the particular electrolyte used.

Table 2 compares the values for Gurley number, bulk ionic conductivity and MacMullin number for a number of commercially available separators. The microcomposite separator as described herein demonstrated as good or better properties as the commercially available separators. All Gurley numbers were obtained using the modified ASTM-D726 test described above.

TABLE 2
Comparison of separator properties.

| | | Total | Bulk | Gurley | |
|---|---|---|---|---|---|
| | Thickness | Porosity | Conductivity | Number | MacMullin |
| Separator | (μ) | (%) | (mS/cm) | (seconds/10 cc) | Number |
| Silica/PVDF separator | 39 | 69 | 2.54 | <0.5 | 7.1 |
| 65:35 silica:PVDF¹ | | | | | |
| Silica:PVDF separator | 34 | 54 | 0.94 | 5 | 20.7 |
| 45:55 silica:PVDF (free | | | | | |
| standing film) | | | | | |
| Silica:PVDF separator | 29 | 45 | 0.41 | 116 | 46.9 |
| 35:65 silica:PVDF (free | | | | | |
| standing film) | | | | | |
| Gore (capacitors) | 25 | 70 | 2.88 | NA | 6.7 |
| Asahi | 20 | 69 | 2.95 | 3.38 | 6.6 |
| (very fast) | 25 | 69 | 2.08 | — | |
| Exxon Tonen E20 MMS | 20 | 44 | 0.738 | 22.1 | NA |
| Most polyolefin separators | 20 | 40-50 | <1 | 10-25 | |
| Celgard 2320 | 20 | 41 | 0.86 | 23.3 | 22.7 |

¹Silica is Syloid C803 from W. R. Grace.

### Preparation of Composite Separator

The solvent system used in the preparation of the coating solution may comprise any solvent system in which at least one component of the coating solution is capable of dissolving the polymer component. Suitable second or further components may be used; if not capable of dissolving the polymer, the additional components can be miscible with the first solvent. Preferably, the solvents are relatively easy to remove during subsequent processing steps. One solvent which has been found to have utility in connection with PVDF-based membranes includes N-methyl pyrrolidinone (NMP), and the NMP may be blended with another solvent such as acetone, ethyl acetate, cyclohexanone and propyl acetate for example, to obtain the appropriate slurry rheology. By way of example, solvents of different boiling points may be used to control solvent evaporation rates and thus film stresses which are generated during drying of the liquid slurry. One specific solvent mixture which was utilized in one implementation of the present invention comprised, on a weight basis, a 40:60 NMP/cyclohexanone mixture, but other solvent combinations are contemplated as well. Suitable solvent systems include 100% NMP, 30% NMP with 70% of propyl acetate, methyl ethyl ketone (MEK), or ethyl acetate. The composite slurry is a relatively homogeneous suspension which is relatively stable in the absence of shear.

In one or more embodiments, the solvent system is selected to provide robust adherence of the separator membrane to adjacent electrode layer(s) without undesirable delamination of the electrode layer from the current collector. Electrode adhesion to the current collector is achieved by an adhesion promoting layer and the binder which holds the composite together. When the electrode layer is deposited, the surface of the current collector may be treated to promote electrode adhesion. In addition, the polymer binder promotes adhesion of the electrode particles to the current collector surface. However, if the solvating properties of the solvent system used to cast the separator membrane are too strong or the permeability of the solvent system into the electrode layer is too high, it may disrupt the structures which provide adhesion, and thereby delaminate the electrode layer from the current collector. The effects of delamination can be quite dramatic and it can render the electrode/separator membrane assembly unusable.

Thus, according to one or more embodiments, the solvent system is selected to provide limited solubility of the binder in the electrode layer and the slurry composition is adjusted so that the amount of slurry penetration into the electrode is minimized. This can be accomplished by appropriate selection of the polymer and solvent system in the casting solution for the separator membrane so that the solvent system has good solubility for the separator polymer, but lesser solubility for the binder of the electrode layer, when the separator polymer for the separator is different than the electrode binder. In one or more embodiments this can be achieved by providing a solvent system that limits the amount of solvent present that would solubilize the electrode binder. By way of example, the solvent is blended with a second solvent having lower solubility for the electrode binder. In one or more embodiments, less than 50 vol %, or less than 30 vol %, of the solvent system is a binder soluble solvent.

In other embodiments, the same polymer is used for the electrode binder and the separator layers. That means that the solvent has the same solubilizing effect on both materials. The solvent system can be adjusted in other ways to prevent delamination of the electrode layer from the electrode. In other embodiments, the viscosity of the solvent system is adjusted to prevent or reduce the level of penetration of the casting solution into the electrode layer. In one or more embodiments, the casting solution remains at the interface with the electrode layer and does not penetrate substantially into the electrode layer. By way of example, it does not penetrate more than 90%, or more than 75%, or more that 50% or more than 25% or more than 10% of the thickness of the electrode layer.

Methods of controlling solution viscosity (and thereby solution penetration) include controlling the solids content of the coating solution. When working with a comma coater, a type of roll coating, low solids content coating solutions can lead to delamination. By increasing the percent solids, and thus the viscosity, delamination can be prevented. For an exemplary silica/PVDF/NMP/acetone system as described herein, 5.5% solids lead to delamination, 8% solids had less delamination, whereas 9% solids had no delamination.

The viscosity of the casting solution can also be adjusted by selection of solvents of differing viscosities, however the magnitude of viscosity change is most easily effected by changing the solids content.

When working with a spray coating system it may not be possible to increase viscosity to a level that would prevent penetration since the ability to spray a quality mist is related to the viscosity, which is typically kept quite low relative to other coating techniques such as slot die. One solution is to reduce the amount of liquid deposited in any given time, since for a given slurry formulation the more liquid that is deposited, the more likely it is to cause delamination. To address delamination in a spray coating system, the number of passes between drying steps is adjusted. In one or more embodiments, multipass deposition of thin layers of the coating solution is employed to reduce delamination.

The inorganic particle material and polymer are combined in the solvent system to form a uniform distribution of inorganic particles in the dissolved polymer/solvent system. The highly uniform distribution of polymer and inorganic material in the coating solution provides a highly uniform distribution of polymer and inorganic materials in the resultant membrane. By blending a poorer solvent into the strong solvent in the coating solution, a suspension of polymer and inorganic filler is created. This suspension helps assure an intimate mixture of the two solids and prevents particulate separation/segregation during the drying step.

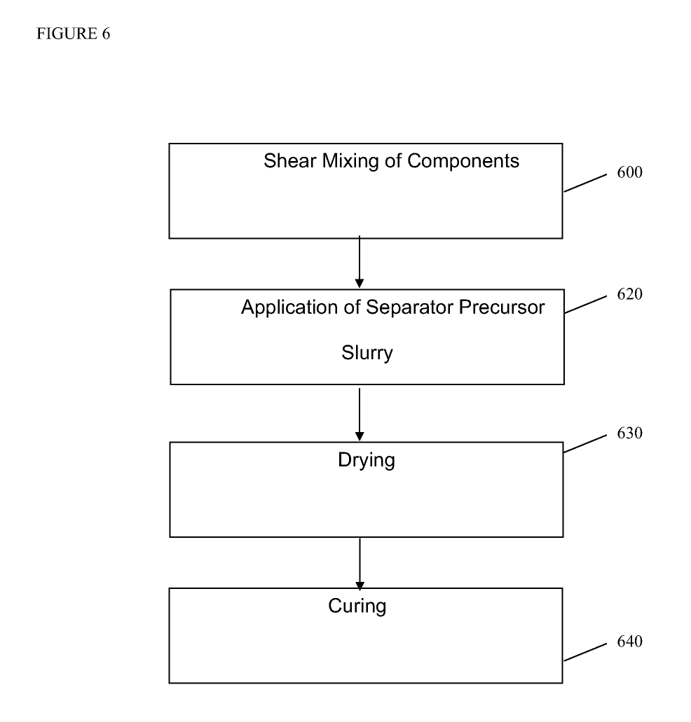

A coating method is described with reference to FIG. 6. In step 600, the coating solution is prepared including a solvent, solvent-soluble or solvent-miscible polymer and inorganic particles. In one or more embodiments, the polymer, liquid solvents and inorganic ingredients are mixed under low shear for an initial period until ingredients are fully wetted and/or dissolved. In a preferred method the polymer and inorganic are first mixed in NMP so that a high level of dispersion is achieved. Then these are submitted to a high shear to disperse the inorganic particles. Next, the second solvent is added, and this mixture can then again be subjected to a high shear mixture until a desired rheology is obtained. A desirable slurry does not contain large agglomerates and does not quickly phase segregate to separate regions of polymer and inorganic materials upon standing but instead remains well dispersed. Without being bound by any mode or theory of operation, it is believed that the solution rheology provides an indication of distribution of particle sizes and agglomeration behavior as well as total particle concentrations. Thus, the type, amount, and duration of mixing is related to the viscosity of the combined materials. More complex and asymmetric shapes and a larger number of particles tend to increase the viscosity of a solution. Such slurry properties may play a role in the final micro- or nano-structure of the layer and its frequency and type of flaws.

In one or more embodiments, polymer and inorganic powder are added in portionwise, with each addition of solids followed by additional mixing. In one or more embodiments, silica is added portionwise to a polymer solvent solution. The silica can be added in 2-4 increments to a polymer solution. In one or more embodiments, the inorganic powder is added to an amount of polymer solution that represents only a portion of the total polymer and solvent content. The inorganic powder is mixed under shear for a time to fully disperse it in the polymer solution. Subsequent further additions of binder (e.g., in increments of 2 to 4) are provided to fully mix the polymer into the mixture. The resulting mixture is a high solids content and additional solvent(s) is added depending of the exact composition, e.g., % solids and solvent ratio) desired in the final slurry.

The coating solution is then coated onto at least one surface, as is indicated in step 620. The surface may be an electrode material or it may be a nonporous substrate. In the former case, no further assembly of the separator and the electrode is needed, as the two are co-assembled. In the latter case, the coated layer can be removed from the non-porous substrate and used as a free standing layer or assembled in as separate step in an electrochemical cell. The thickness of the layer coated onto the surface will depend upon the particular composition of the coating solution and the final thickness desired in the electrochemical cell. Other coating techniques may be employed according to one or more embodiments of the invention, so long as they are susceptible to depositing a composition including a mixed ceramic and particle composition. Exemplary techniques includes doctor blading, roll coating, slot die coating, ink jet printing, spin coating, gravure coating and screen printing, or other coating methods. Coating is typically carried out under conditions that provide for solvent welding between the separator membrane layer and the adjacent electrode layer. A slot die coater, in which a coating liquid is forced out from a reservoir through a slot by pressure, and transferred to a moving web, is used in certain exemplary methods of coating the substrate with the coating mixture.

Following the coating, step 630 illustrates that the solvent is removed from the coating mixture to leave a solid porous body of polymer/ceramic particles on the electrode. The solvent may be removed by evaporation, and this evaporation may be fostered by use of heating and/or low pressure conditions. In some instances, the solvent may be extracted by the use of an extraction solvent which is a non-solvent for the polymer. Such techniques are known in the art.

In one or more embodiments, the polymer is a thermoplastic and has a glass transition temperature (Tg) and may or may not have a melt temperature (Tm). In one or more embodiments, after coating a coating onto the support, the layer is subjected to a treatment selected to reduce the stress in the layer by curing the layer. The polymers may be cured by treatment above their glass transition or melting temperature so as to modify or enhance its physical properties (step 640) without negatively impacting the micro- or nano-structure or otherwise negatively changing the properties. Curing and/or cross-linking may be accomplished by heating, as is known in the art (e.g., ion-beam, e-beam, etc.). The drying step and the curing step may or may not be carried out in serial steps. In the case of thermoplastic polymers, such as PVDF, curing is accomplished by heating the composite beyond the host polymer Tm and then allowing it to cool down. In other embodiments, the layer is heated at or above the glass transition temperature of the polymer binder.

The result of the foregoing process is the deposition onto an electrode (or other suitable substrate) of a layer of separator layer comprised of polymer and ceramic particulate material that are intimately combined and microporous. The process can be used to apply a porous separator membrane onto a supporting substrate such as an electrode. These membrane coatings have been found to be durable and highly adherent. The membrane coated electrode may then be incorporated into battery cells, and the cell may include coatings on either or both of the anode and cathode electrodes. The electrode can be processed into a battery, e.g., by assembly the current collector, positive electrode, separator membrane, negative electrode and current collector layers into a structure and then bending or rolling the structure into the appropriate form. In one or more embodiments, a nonaqueous electrolyte is used and includes an appropriate lithium salt dissolved in a nonaqueous solvent. The electrolyte may be infused into a porous separator that spaces apart the positive and negative electrodes. In one or more embodiments, a microporous electronically insulating separator is used.

Numerous organic solvents have been proposed as the components of Li-ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li-ion battery electrolyte solutions include γ-BL, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate and the like. These nonaqueous solvents are typically used as multicomponent mixtures.

A solid or gel electrolyte may also be employed. The electrolyte may be a high molecular weight solid polymer electrolyte, such as a gel, provided that the materials exhibit lithium conductivity. Exemplary compounds include poly(ethylene oxide), poly(methacrylate)ester based compounds, or an acrylate-based polymer, and the like, as well as their homopolymers, copolymers, and block copolymers. These may be used in the dry state, in which case heating to temperatures greater than 50° C. may advantageously improve conductivity, or they may be wetted with the usual electrolytes common to Li-Ion batteries, or they may be used dry at room temperature in which case the conductivity is low and the battery will have power limitations.

As the lithium salt, at least one compound from among LiClO₄, LiPF₆, LiBF₄, LiSO₃CF₃, LiN(SO₂CF₃)₂, LiN(SO₂CF₂CF₃)₂ and the like are used. The lithium salt is at a concentration from 0.5 to 1.5 M, or about 1.3 M.

In other embodiments, the process can be used to apply a porous separator membrane onto a sacrificial support, such as a polymer film. The resultant membrane can be transferred to an electrode or other element. The porous composite layer is not required to be formed directly onto the electrode, but can be formed on other surfaces. This transfer is done in a manner which insures excellent adhesion to the electrode substrate. Additional manufacturing steps can be avoided by applying the separator directly on the electrode surface. The properties of such films, measured in their free standing state—are provided above in the table above.

In one or more embodiments, one or more cell assemblies can be combined into an integral body that has high degree of connectivity and low resistance. It has been surprisingly discovered that stacked electrode layers with these composite separators can be laminated under heat and pressure without significant loss of porosity, cracking or other defect formations. Conventional understanding would predict that the forces needed to fuse or laminate the electrode layers would degrade the porous layers leading to short circuiting and reduced conductivity (higher resistance).

Applicants have surprisingly discovered that robust laminated cells can be obtained without such detrimental effects. While not being bound by any particular mode or theory of operation, higher polymer content in the porous separator may provide sufficient material resilience to allow the stacked cells to be laminated without cracking or significant densification. In one or more embodiments, the separator layer may include about 40-65 wt % polymer.

The specific properties of the membrane in terms of composition, thickness, physical properties and the like will depend upon particular battery systems in which the membranes are to be incorporated. Further illustration is provided in the following examples, which are presented for the purpose of illustration only and are not intended to be limiting of the invention.

### EXAMPLE 1

### Preparation of a Porous Separator

Membranes for lithium-ion cells were prepared from a mixture of larger particle silica and PVDF. Membranes were prepared from Kureha 7208 PVDF-NMP solution and silica with an average particle size of 3.4-4.0 μm available from W.R. Grace under the trade name Syloid C803. The final coating mixture had a ratio of silica:polymer of 65:35 on a weight basis, and a 12% loading of these solids in a 40:60 (volume/volume) mixture of NMP and cyclohexanone blend.

A polymer pre-paste was formed initially as a high solids content viscous mixture. The resultant mixture was then blended with additional NMP and cyclohexanone to obtain the desired solids content and solvent blend. Mixer is a Speed Mixer DAC 600 FVZ from Flack Tek Inc.

To prepare the polymer pre-paste, the silica was added to a portion of the total polymer binder (40% of ultimate total binder solution volume) in three increments (typically 40%, 40%, and 20%). After each incremental addition the blend was mixed, e.g., at 1600 RPM for one minute. Once all the inorganic material is added, the combination is mixed several times at increasing shear rates (1600 rpm-2000 rpm) with cooling permitted during mixing intervals. Once the inorganic component is fully blended, four separate further additions of the binder (15% of the total for each addition) were mixed at 2000 RPM for four minutes (cool in between mixes) and mixing was continues for about 20 minutes to completely homogenize the solids coating mixtures.

Next, additional solvent was added to obtain the desired composition. In one example, NMP is added and mixed into the coating composition, followed by cyclohexanone in four separate additions of equally size. Shear mixing continued to homogenize the coating composition.

A modified comma coater (by Toyo) with a slot die attachment manufactured by EDI with a maximum slot width of 7 inches was used to coat the substrate with the coating composition. IR heaters from Heraeus Nobilite (approximately 500 watts each) were used for upper surface drying. The unit was operated at 50% total IR intensity and was positioned ˜10 cm above the web just after the point where the wet slurry was dispensed. A silicone heating pad was placed in the drying chamber such that the coated electrode is heated from underneath. The coating was delivered to the moving web at 1 meter/minute and was dried using IR at about 80-100° C. This coating composition was applied to either a body of anode or cathode material intended for use in a lithium-ion cell. The dry thickness of the application was approximately 30 microns and it was applied in a single coating step to the anode or cathode or in two steps of equal thickness of 15 microns to anode and cathode each. In one embodiment, the thickness of the slurry coating was reduced by a factor of 8.3 upon drying. Actual thickness reduction is a function, at least in part, of the solids loading in the coating slurry.

After coating, the electrode was vacuum dried at 80° C. for 1 hour and then finally cured at 200° C. for 15-60 minutes. The resulting electrode/separator membrane structures were employed in a variety of cell architectures including coin cells, pouch cells, and stacked prismatic cells.

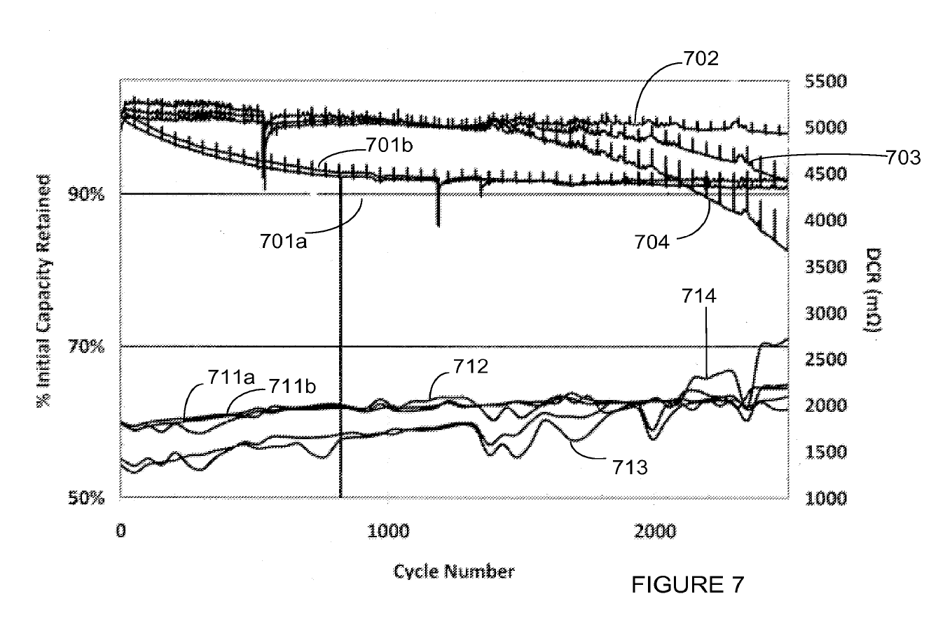

These coated electrodes were found to function very well. In particular, 20 mAh prismatic cells incorporating the foregoing separator were shown to function very well in cycle life performance tests compared to cells without such a separator. FIG. 7 is a plot of % initial capacity vs. cycle number and DC resistance vs. cycle number for a cell including a 30 μm composite separator. Plots 701a and 701b show the % initial capacity testing results for a Celgard baseline material. Plots 711a and 711b show the DC resistance testing results for the Celgard baseline material. Plots 702 and 712 show the % initial capacity and DC resistance resting results, respectively, for a 30 μm composite separator coated onto the cathode only. Plots 703 and 713 show the % initial capacity and DC resistance testing results, respectively, for a 15 μm composite separator coated onto the cathode and a 15 μm composite separator coated onto the anode. Plots 704 and 714 shows the % initial capacity and DC resistance testing results, respectively, for a 30 μm composite separator coated onto the anode only. These plots show that single layer pouch cells utilizing the foregoing separators showed no appreciable capacity loss after more than 1500 cycles at 1.5 C charge/2.5 C discharge rates.

### EXAMPLE 2

### Comparison of Coated Separators in Pouch Cells

A porous membrane prepared substantially as described in Example 1 was prepared with the following modifications. The silica separator was laid down either as one layer on a single electrode or as two layers on both the positive and negative electrode, in which each electrode had a layer of one-half the total thickness. In combination, the two separator layers had the same thickness as the single layer. The layers were coated using a slot die coater.

Cells were prepared as a single layer pouch format by placing the coated cathode made of a lithium iron phosphate material (LFP) directly adjacent to a counter electrode, which is carbon that may or may not also be coated with the composite separator, in a pouch container that is sealed on three sides, filling the cell with electrolyte and then sealing the fourth side so that the interior is totally isolated from the external environment.

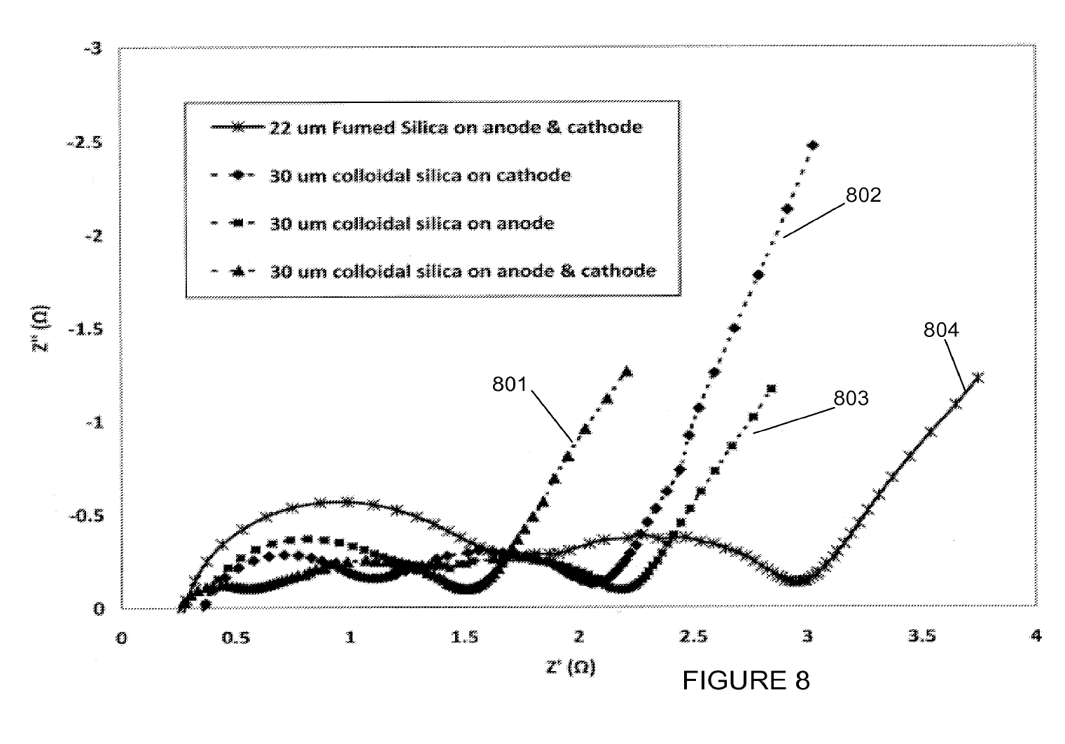

An electrochemical impedance spectroscopic analysis was completed on the cells, as shown in FIG. 8. The sin wave voltage amplitude is 20 mvolt, the applied potential is the open circuit potential, and the frequency spectrum is 10⁻² to 10⁶ Hz. The plot is imaginary vs. real impedance and the resistance used to calculate the material properties is the impedance value when the capacitance is lowest—this is the intercept of the x-axis. The resistance is measured in ohms. For comparison, the electrochemical impedance of a pouch cell having a 22 μm thick fumed silica composite membrane (17 μm deposited on the cathode and 5 μm deposited on the anode) was determined and is shown in plot 804 of FIG. 8. Plot 801 shows the test results for a 30 μm total thickness composite membrane where part of the membrane was coated onto the cathode and another part was coated on the anode. Plot 802 shows the test results for a 30 μm total thickness composite membrane where the membrane was coated onto the cathode only. Plot 803 shows the test results for a 30 μm total thickness composite membrane where the membrane was coated onto the anode only.

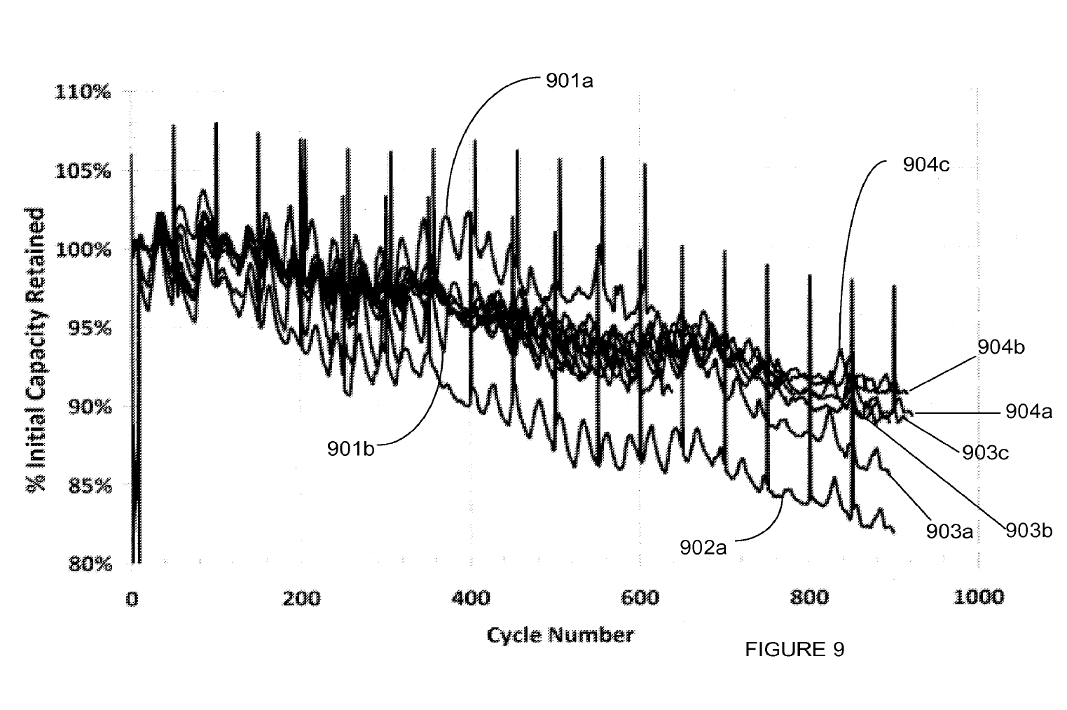

Meanwhile, FIG. 9 is a plot of % initial capacity vs. cycle number of 20 mAh single layer pouch cells in a 3 C/−5 C room temperature cycle test. Three types of cells included a composite membrane separator, and one cell was without a composite membrane separator. The figure shows that the % initial capacity retained for each cell having a composite membrane separator was higher than the baseline cell with a composite membrane separator. Plots 901a and 901b show the test results for a non-laminated cell including a composite membrane separator. Plot 902a shows the test results for a non-laminated cell having a polyolefin separator. Plots 903a, 903b, and 903c show the test results for a laminated composite membrane separator with low compaction (2-3% reduction of total cell thickness versus non-laminated). Plots 904a, 904b, and 904c show the test results for a laminated composite membrane separator with high compaction (5% reduction of total cell thickness versus non-laminated). The laminated composite membrane separator with low compaction was achieved by pressing the assembled electrodes with about 1000 psi at about 120° C. for about 2 seconds. The laminated composite membrane separator with high compaction was achieved by pressing the assembled electrodes with about 1200 psi at about 120° C. for about 5 seconds.

The foregoing illustrates one specific embodiment of this invention. Other modifications and variations of the invention will be readily apparent to those of skill in the art in view of the teaching presented herein. The foregoing is intended as an illustration, but not a limitation, upon the practice of the invention. It is the following claims, including all equivalents, which define the scope of the invention.

1. A separator for an electrochemical cell, comprising:
a porous composite layer having a total thickness in the range of about 4 μm to about 50 μm comprising inorganic particles having an average aggregate particle size in the range of about 0.5 μm to about 6 μm in an electrochemically stable polymer matrix.

2. The separator of claim 1, wherein the layer has a pore volume fraction of greater than 25%.

3. The separator of claim 1, wherein the layer has a pore volume fraction of about 50% to about 70%.

4. The separator of claim 1, wherein the layer has a total thickness in the range of about 8 μm to about 50 μm.

5. The separator of claim 1, wherein the layer has a total thickness in the range of about 15 μm to about 40 μm.

6. The separator of claim 1, wherein the separator is supported on an electrode.

7. The separator of claim 1, wherein separator is of sufficient mechanical strength to provide a free standing layer.

8. The separator of claim 1, wherein the inorganic particles have an average aggregate particle size in the range of about 2 μm to about 6 μm.

9. The separator of claim 1, wherein the inorganic particles have an average aggregate particle size in the range of about 3 μm to about 4 μm.

10. The separator of claim 1, wherein the inorganic particles have an average aggregate particle size in the range of about 0.5 μm to about 3 μm.

11. The separator of claim 1, wherein the inorganic particles have an average aggregate particle size in the range of about 1 μm to about 2.5 μm.

12. The separator of claim 1, wherein the inorganic particles are selected from the group consisting of natural and synthetic silicas, zeolites, aluminas, titanias, metal carbonates, zirconias, silicon phosphates, and silicates.

13. The separator of claim 1, wherein the inorganic particles comprise precipitated silica.

14. The separator of claim 1, wherein the inorganic particles and polymer are in a weight ratio of about 95:5 to about 35:65.

15. The separator of claim 1, wherein the inorganic particles and polymer are in a weight ratio of about 65:35 to about 45:55.

16. The separator of claim 1, wherein the polymer matrix comprises a polymer which is electrochemically compatible with Li-ion cells.

17. The separator of claim 16, wherein the polymer is selected from the group of latex polymers, cellulosics, and polyvinylidene fluoride-based polymers.

18. The separator of claim 1, wherein the layer has a Gurley number of less than about 2 when tested via ASTM-D726 using 100 cubic centimeters of air.

19. The separator of claim 1, wherein the layer has a Gurley number of less than about 1 when tested via ASTM-D726 using 100 cubic centimeters of air.

20. An electrode and separator assembly for use in an electrochemical cell, comprising:
a first electrode layer disposed on a first current collector, said first electrode layer comprising at least electroactive particles and a binder;
a second electrode layer disposed on a second current collector, said second electrode layer comprising at least electroactive particles and a binder; and
a porous composite separator layer according to claim 1.

21. The electrode/separator of claim 20, wherein the separator layer has a total thickness in the range of about 20 μm to about 40 μm.

22. The electrode/separator assembly of claim 20, wherein a portion of the separator thickness is disposed on each of the electrode layers.

23. A method of preparing a electrode/separator assembly for an electrochemical cell, said method comprising:
providing a coating solution, said coating solution comprising a polymer, solvent system for solubilizing at least a portion of said polymer, and inorganic particles having an average particle size in the range of about 0.5 μm to about 6 μm dispersed in said coating solution;
coating a surface with a layer of said coating solution, at a thickness to provide a final thickness, after solvent system removal, in the range of about 12 to about 50 μm; and
removing at least a portion of the solvent system from said coating solution layer to deposit a porous separator.

24. The method of claim 23, wherein the average particle size is about 1 μm to about 6 μm.

25. The method of claim 23, wherein the surface comprises a porous composite electrode layer comprising at least electroactive particles and a binder.

26. The method of claim 23, wherein the surface comprises a non-porous surface that is chemically inert with respect to the coating solution.

27. The method of claim 23, further comprising curing said polymer.

28. The method of claim 23, wherein said curing comprises heat treating the assembly.

29. The method of claim 23, wherein the coating solution comprises a weight ratio of silica particles and polymer in the coating solution of about 95:5 to about 35:65.

30. The method of claim 23, wherein the coating solution comprises a weight ratio of silica particles and polymer in the coating solution of about 65:35 to about 45:55.

31. The method of claim 23, wherein the surface includes an electrode, and the electrode is adhered to a current collector, and wherein the solvent system is a mixture of solvents and the solvents include a first liquid that is a solvent for the polymer and a second liquid that is a poorer solvent for the polymer than the first liquid and the proportion of first liquid to second liquid is selected to render the adhesion of the electrode to the current collector after coating substantially unchanged relative to the adhesion of the electrode to the current collector before coating.

32. The method of claim 23, wherein the surface includes an electrode, and the electrode is adhered to a current collector, and wherein the solvent system is a mixture of solvents and the solvents include a first liquid that is a solvent for the binder and a second liquid that decreases the viscosity of the coating solution and the proportion of first and second liquids vs. the amount of solids is selected to render the adhesion of the electrode to the current collector after coating substantially unchanged relative to the adhesion of the electrode to the current collector before coating.

33. The method of claim 23, wherein said solvent system comprises N-methyl pyrrolidone.

34. The method of claim 23, wherein said solvent system comprises a mixture of N-methyl pyrrolidone and a diluting solvent selected from the group consisting of acetone, cyclohexanone, propyl acetate, methyl ethyl ketone and ethyl acetate.

35. The method of claim 23, wherein coating is carried out by slot die coating.

36. The method of claim 23, wherein removing said solvent comprises evaporating said solvent.

37. A battery which includes the separator of claim 1.

38. The battery of claim 37, wherein said battery is a lithium ion battery.
